(19) United States
(12) Patent Application Publication
(10) Pub. No.: US 2025/0271747 A1
(43) Pub. Date: Aug. 28, 2025

(54) Multifunctional Image Mapping Device

(71) Applicant: Guoqiang SHEN, Zhejiang (CN)

(72) Inventor: Guoqiang SHEN, Zhejiang (CN)

(21) Appl. No.: 18/587,046

(22) Filed: Feb. 26, 2024

(51) Int. Cl. G03B 23/10; G03B 21/14; G03B 21/20; G03B 21/64; G03B 29/00

(52) U.S. Cl. CPC G03B 23/105; G03B 21/145; G03B 21/208; G03B 21/64; G03B 29/00

(57) ABSTRACT

The present invention discloses a multifunctional image mapping device, which comprises a main body shell, an image mapping apparatus, a control apparatus and a sound apparatus, wherein an inner bracket, a mapping bracket and a lens bracket are arranged in the main body shell; the image mapping apparatus comprises a mapping disc, a light source and a lens assembly; a mapping port is arranged on the mapping disc; mapping sheets are arranged in the mapping port; the mapping disc is provided with coding information corresponding to each mapping sheet; the mapping disc is arranged on the mapping bracket; the light source is arranged in the mapping bracket; the mapping port is aligned with the lens assembly and the light source through the rotation of the mapping disc, and a control apparatus and a sound apparatus are also arranged in the main body shell.

### TECHNICAL FIELD

The present invention relates to the field of projection device, in particular to a multifunctional image mapping device.

### BACKGROUND

At present, there are many similar products of projection music box on the market, and all of them are manually operated to realize the music playback of each picture, so the detailed information of the currently displayed picture cannot be accurately reflected. Therefore, it can't have a correct understanding and counseling effect on children. Due to the defects in the overall design of the product, the picture information of the product is not rich enough, and the picture and the built-in music of the host can not be replaced casually, so the product is single and not rich.

For example, a projection toy is disclosed in the patent document “Projection Toy” with US application number of U.S. Pat. No. 1,176,842, which includes a top shell. By arranging one side of the convex end of the first convex lens close to one side of the convex end of the second convex lens, the present invention can effectively improve the intensity of photography, increase the projection distance, and provide a clear visual field for children in use. The film turntable is rotatably installed in the shell, and the film can rotate around the rotating shaft under the action of two clamps. So that users can directly change the patterns, thus improving the playability, and solving the problem of single product pictures; however, the present invention only realizes the projection by rotating and changing the pictures, can not provide the sound matching with the current projection content, and only provides the pictures, which is rather boring.

However, the patent document “Toy Projector” with a US patent number of 20150147932 discloses a toy projector with animal or peculiar appearance. Although it is suitable for playing all kinds of images, audio and video content, it includes a microcomputer, which processes what is played in the data file. There is a plush toy package outside the device, which cannot be grasped, and its operation steps are complicated, and the preparation time before projection is long, and thus it cannot be projected quickly.

Based on the above problems, it is necessary to provide a brand-new mapping device, which has the advantages of high synchronization, strong playability, convenient use and not easy to damage.

### SUMMARY

The present invention provides a multifunctional image mapping device, which includes a main body shell, an image mapping apparatus, a control apparatus and a sound apparatus;
wherein, an inner bracket, a mapping bracket and a lens bracket are arranged inside said main body shell; and
wherein, said image mapping apparatus comprises a mapping disc, a light source and a lens assembly, wherein said mapping disc is provided with a plurality of mapping ports, mapping sheets are arranged in the plurality of mapping ports, and said mapping disc is also provided with coding information corresponding to each mapping sheet, wherein said mapping disc is rotatably coupled to said mapping bracket, said lens assembly is arranged in said lens bracket, and said light source is arranged in said mapping bracket, wherein said mapping port can be aligned with the lens assembly and the light source through the rotation of said mapping disc;
wherein, said control apparatus and said sound apparatus are arranged on said inner bracket, and said control apparatus comprises a circuit board which is electrically connected with said image mapping apparatus and said sound apparatus; and
wherein when a user rotates said mapping disc, said circuit board recognizes the coding information of said mapping sheet aligned with said lens assembly, and controls said light source and said sound apparatus to work according to a preset program.

The present invention provides another multifunctional image mapping device, which includes a main body shell, an image mapping apparatus, a control apparatus and a sound apparatus;
wherein, an inner bracket, a mapping bracket, a lens bracket and a knob are arranged inside said main body shell; and
wherein, said image mapping apparatus comprises a mapping disc, a light source and a lens assembly, wherein said mapping disc is provided with a plurality of mapping ports, mapping sheets are arranged in said mapping ports, and said mapping disc is also provided with coding information corresponding to each mapping sheet, wherein said mapping disc is rotatably coupled to said mapping bracket, said lens assembly is arranged in said lens bracket, and said light source is arranged in said mapping bracket, wherein said mapping port can be aligned with said lens assembly and said light source through the rotation of said mapping disc;
wherein said knob is operatively connected to said lens assembly to adjust a focal length of said lens assembly; and
wherein, said control apparatus and said sound apparatus are arranged on said inner bracket, and said control apparatus comprises a circuit board, wherein said circuit board is provided with an identification probe which is in contact with said mapping disc, and when said mapping disc rotates, said identification probe can read the coding information of said mapping sheet aligned with said lens assembly; and
wherein when said control apparatus receives an input instruction from a user, said control apparatus controls said light source and said sound apparatus to work according to a preset program.

The present invention further provides an image mapping method, which includes providing a multifunctional image mapping device including a main body shell, an image mapping apparatus, a control apparatus and a sound apparatus;
wherein, an inner bracket, a mapping bracket, a lens bracket and a knob are arranged inside said main body shell; and
wherein, said image mapping apparatus comprises a mapping disc, a light source and a lens assembly, wherein said mapping disc is provided with a plurality of mapping ports, mapping sheets are arranged in said mapping ports, and said mapping disc is also provided with coding information corresponding to each mapping sheet, wherein said mapping disc is rotatably coupled to said mapping bracket, said lens assembly is arranged in said lens bracket, and said light source is arranged in said mapping bracket, wherein said mapping port can be aligned with said lens assembly and said light source through the rotation of said mapping disc;
wherein said knob is operatively connected to said lens assembly to adjust a focal length of said lens assembly; and
wherein, said control apparatus and said sound apparatus are arranged on said inner bracket, and said control apparatus comprises a circuit board, wherein said circuit board is provided with an identification probe which is in contact with said mapping disc, and when said mapping disc rotates, said identification probe can read the coding information of said mapping sheet aligned with said lens assembly; and
wherein when said control apparatus receives an input instruction from a user, said control apparatus controls said light source and said sound apparatus to work according to a preset program; and
the method comprises the following steps:
turning on said multifunctional image mapping device through said control apparatus;
rotating said mapping disc and selecting a mapping sheet to be mapped;
rotating said knob to select an appropriate focal length; and
mapping by said control apparatus.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is an overall view of a multifunctional image mapping device;

FIG. 2 is an exploded view of a multifunctional image mapping device;

FIG. 3 is a sectional view of a multifunctional image mapping device;

FIG. 4 is a partial view of a mapping bracket and a lens bracket in a multifunctional image mapping device;

FIG. 5 is a front view of a mapping disc in a multifunctional image mapping device;

FIG. 6 is an exploded view of a mapping disc in a multifunctional image mapping device;

FIG. 7 is a front view of a main body of the mapping disc in a multifunctional image mapping device;

FIG. 8 is a partial view of a mapping disc and an identification apparatus in a multifunctional image mapping device;

FIG. 9 is an internal structural view of a multifunctional image mapping device;

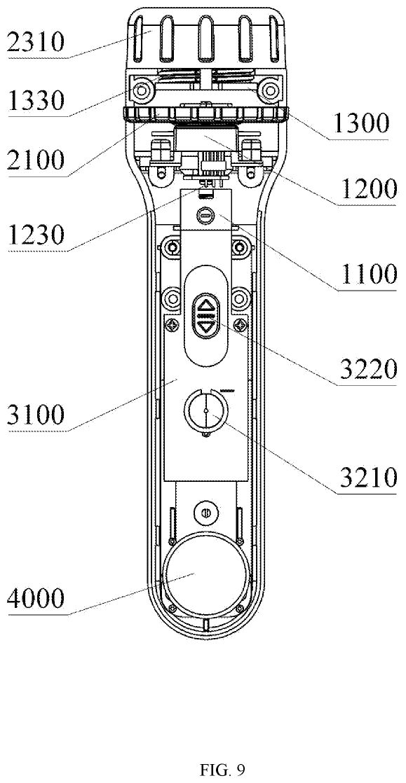

FIG. 10 is a partial view of a knob and a mapping disc in a multifunctional image mapping device;

FIG. 11 is an internal view of the lower end of the main body shell in a multifunctional image mapping device;

FIG. 12 is a view of a cover plate in a multifunctional image mapping device.

In the drawings: Main body shell (1000); Inner bracket (1100); Battery assembly (1110); Mapping bracket (1200); Condenser lens (1210); Identification apparatus (1230); Spring probe (1231); Base point probe (1232); Resistance identification probe (1233); Gear position identification probe (1234); Lens bracket (1300); First lens (1310); Second lens (1320); Adjusting thread (1330); Upper end (1400); Lower end (1500); Battery cover plate (1600); Cover plate (1700); Fixing block (1710); Image mapping apparatus (2000); Mapping disc (2100); Mapping port (2110); Rotating shaft (2160); Mapping sheet (2120); Mapping disc main body (2101); Port disc (2130); Base point area (2131); Resistance value identification area (2132); Gear recognition area (2133); Mapping sheet placement area (2150); Coding disc (2140); Mapping disc upper cover (2102); Light source (2200); Lens assembly (2300); Knob (2310); Control apparatus (3000); Circuit board (3100); Control button (3200); Mapping switch (3210); Start switch (3220); Sound apparatus (4000); Speaker hole (4100).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

As a preferred embodiment of the present invention, in order to solve the problem that the current projected toy product picture is single and audio content corresponding to the projected picture cannot be provided, the present invention provides a multifunctional image mapping device.

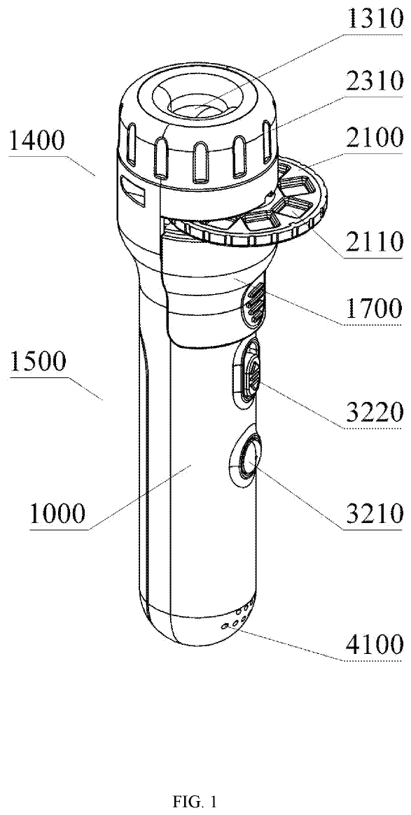

Referring to FIGS. 1 to 3, the multifunctional image mapping device includes a main body shell 1000, an image mapping apparatus 2000, a control apparatus 3000 and a sound apparatus 4000. Inside the main body shell 1000, there are an inner bracket 1100, a mapping bracket 1200 and a lens bracket 1300. The whole main body shell 1000 is divided into an upper end 1400 and a lower end 1500, both of which have a maximum diameter. The upper end 1400 is fixedly connected to the lower end 1500 through arc transition, and the maximum diameter of the upper end 1400 is greater than that of the lower end 1500. The inner bracket 1100 is arranged at the lower end 1500 of the main body shell 1000, and the mapping and lens bracket 1300 are arranged at the upper end 1400 of the main body shell 1000. From top to bottom, there are a lens bracket 1300, a mapping bracket 1200 and an inner bracket 1100 in turn.

Referring to FIGS. 1 to 3, the image mapping apparatus 2000 includes a mapping disc 2100, a light source 2200 and a lens assembly 2300. In this embodiment, the mapping disc 2100 is provided with eight mapping ports 2110, and each mapping port 2110 is internally provided with a mapping sheet 2120. The mapping disc 2100 has coding information corresponding to each mapping sheet 2120, and the mapping disc 2100 is rotatably coupled to the mapping bracket 1200; the lens assembly 2300 is arranged in the lens bracket 1300, and the light source 2200 is arranged in the mapping bracket 1200. By rotating the mapping disc 2100, different mapping ports 2110 can be selected to align the lens assembly 2300 and the light source 2200.

Referring to FIGS. 1 to 3, the control apparatus 3000 and the sound apparatus 4000 are arranged on the inner bracket 1100. The control apparatus 3000 includes a circuit board 3100, which is electrically connected with the image mapping apparatus 2000 and the sound apparatus 4000. When the user rotates the mapping disc 2100, the circuit board 3100 recognizes the coding information of the mapping sheet 2120 in the corresponding mapping port 2110 at present, and controls the light source 2200 and the sound apparatus 4000 to work according to the preset program, so as to map and play sound.

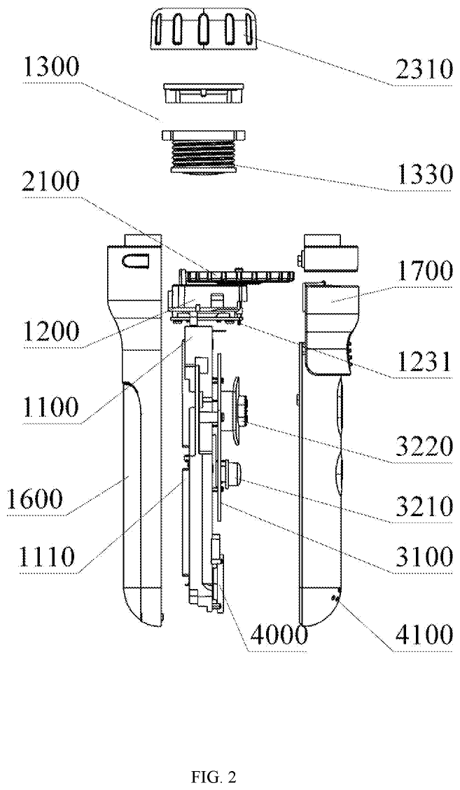

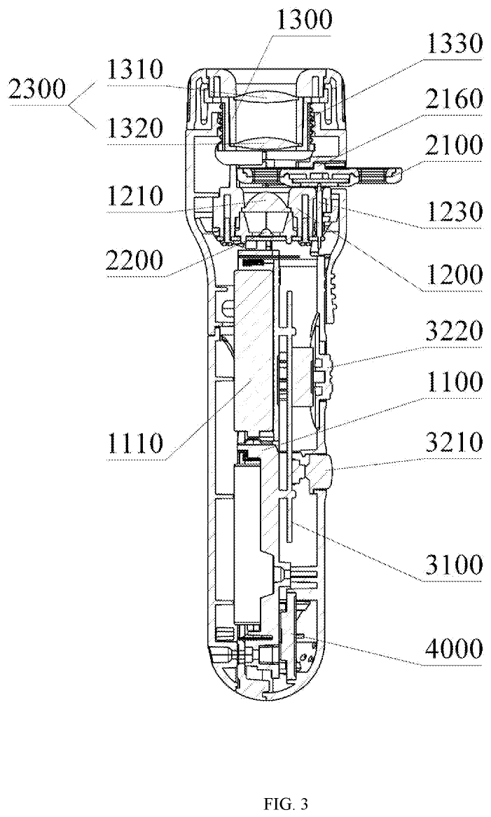

Referring to FIGS. 2 and 3, the lens assembly 2300 includes a first lens 1310 and a second lens 1320, and a condenser lens 1210 is also arranged above the light source 2200. The mapping sheet 2120 on the mapping disc 2100 is located between the second lens 1320 and the condenser lens 1210. The light source 2200 is turned on by the mapping switch 3210 in the control apparatus 3000 for mapping, and the light beam generated by the light source 2200 passes through the condenser lens 1210, the mapping sheet 2120, the second lens 1320 and the first lens 1310 for mapping.

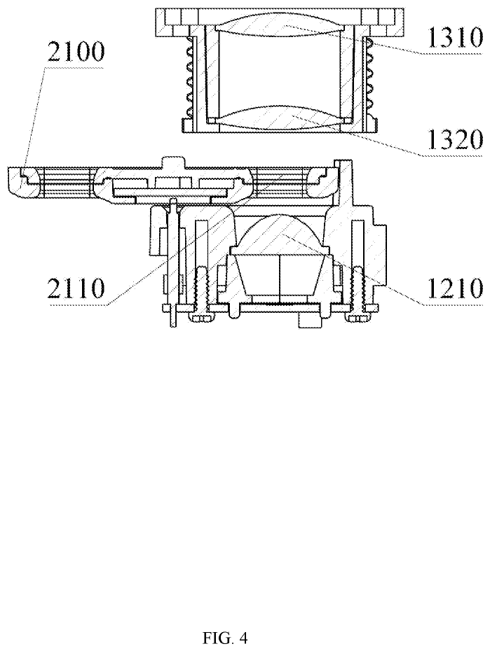

Referring to FIG. 4, the condenser lens 1210, the mapping port 2110, the mapping sheet 2120 (not shown in the figure) in the mapping port 2110, the second lens 1320 and the first lens 1310 are all in the same straight line direction, and the condenser lens 1210 can focus the light beam generated by the light source 2200 on the mapping sheet 2120 to obtain the best mapping effect, provide illumination with sufficient degree and uniformity, and ensure the mapping.

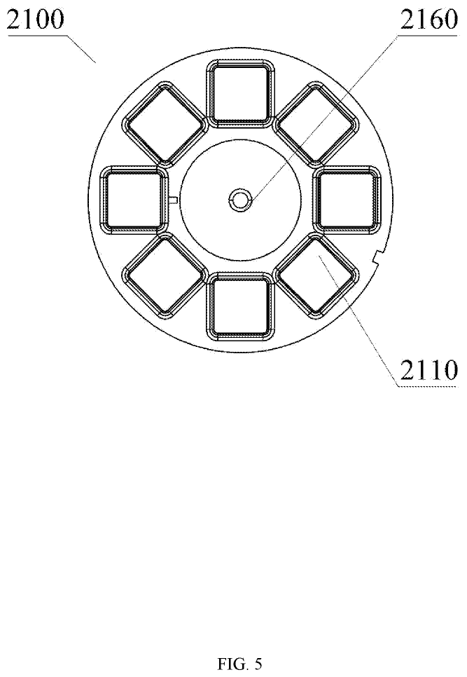

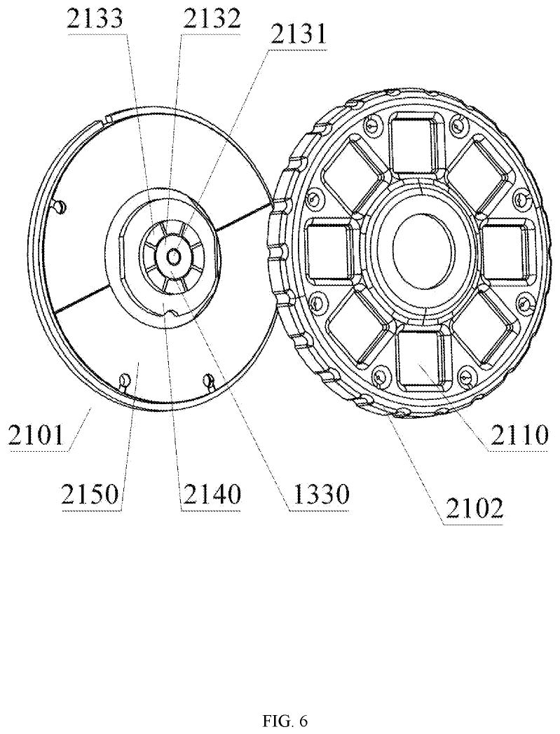

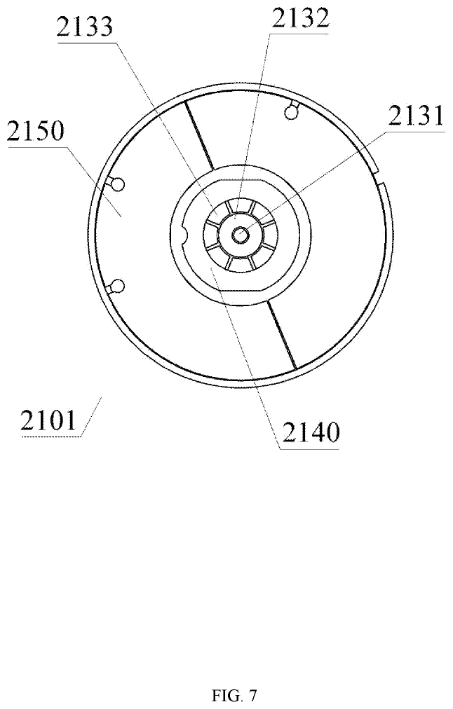

Referring to FIGS. 5 to 7, the mapping disc 2100 is composed of a mapping disc main body 2101 and a mapping disc upper cover 2102. The mapping disc main body 2101 is divided into a port disc 2130, a coding disc 2140 and a mapping sheet placement area 2150. The port disc 2130 includes a resistance value identification area 2132, a base point area 2131 and a gear recognition area 2133. Eight resistance values with different gears are set in the base point area 2131 and the resistance value identification area 2132, and eight different gear values are uniformly set in the gear recognition area 2133, and each gear value corresponds to the resistance value of each gear one-to-one, respectively representing the contents of different mapping sheets 2120. The port disc 2130 is electrically connected with the circuit board 3100, and a coding disc 2140 is arranged on the back of the port disc 2130, and the coding disc 2140 is provided with pre-stored coding information. Mapping sheets 2120 are placed on the mapping sheet placement area 2150, and each mapping sheet 2120 corresponds to the code on the coding disc 2140; the mapping disc 2100 is also provided with a rotating shaft 2160, which is located in the center of the mapping disc 2100, and the mapping ports 2110 are distributed on the mapping disc 2100 at the same angle with the rotating shaft 2160 as a center.

In other embodiments, the resistance values of eight different gears set in the base point area 2131 and the resistance value identification area 2132 can be changed to four different gears or six different gears or any other desired number of gears.

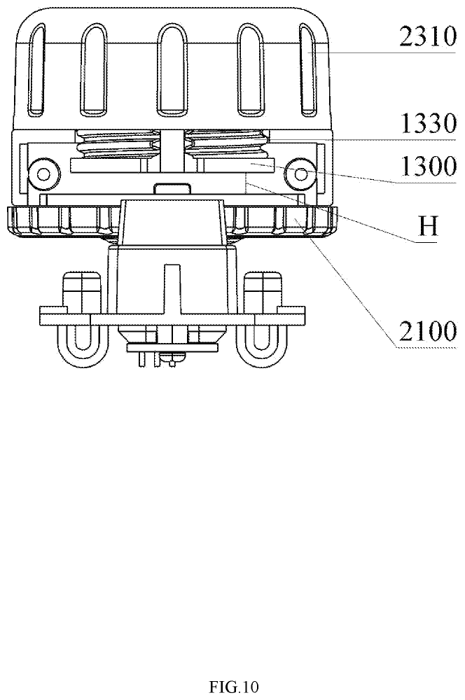

Referring to FIG. 10, a knob 2310 is arranged outside the lens assembly 2300, and an adjusting thread 1330 is arranged on the lens bracket 1300. Rotating the knob 2310 can drive the lens bracket 1300 to adjust the height of the lens bracket 1300, thereby adjusting the distance h between the lens bracket 1300 and the mapping disc 2100, thereby adjusting the focal length. The design of the knob 2310 and the adjusting thread 1330 enables the height of the lens bracket 1300 to be accurately adjusted, so as to realize the precise control of the focal length. By rotating the knob 2310, the distance between the lens bracket 1300 and the mapping disc 2100 can be flexibly adjusted to meet the different use requirements of users.

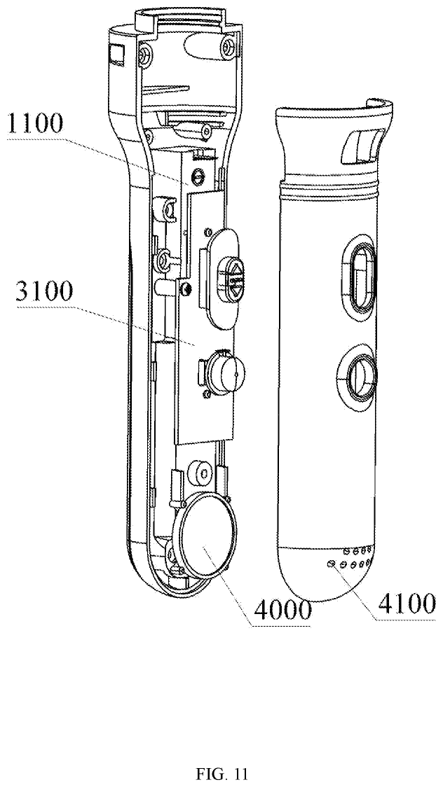

Referring to FIG. 11, the main body shell 1000 is provided with a plurality of speaker holes 4100, the positions of which correspond to and are above the sound apparatus 4000, and the setting of the speaker holes 4100 can provide a sound propagation path, making the sound clearer and louder; the position of the speaker hole 4100 corresponding to the sound apparatus 4000 can increase the volume of the sound, so that the sound is louder, and the position of the speaker hole 4100 is above the sound apparatus 4000, so that the sound propagation direction can be optimized, and the sound propagation can be more uniform. The arrangement of a plurality of speaker holes 4100 can improve the sound effect and enrich the sound quality.

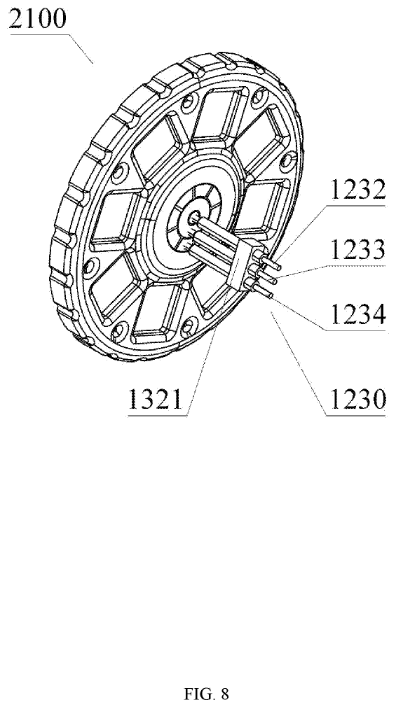

Referring to FIGS. 2 to 8, the mapping bracket 1200 is also provided with an identification apparatus 1230. In this embodiment, the identification apparatus 1230 is composed of three spring probes 1231 with different purposes, including a base point probe 1232, a resistance identification probe 1233 and a gear position identification probe 1234, wherein the base point probe 1232 is in contact with the base point area 2131, the resistance identification probe 1233 is in contact with the resistance value identification area 2132, and the gear position identification probe 1234 is in contact with the gear recognition area 2133. When the multifunctional image mapping device works, the current resistance value is identified and read by the base point probe 1232 and the resistance identification probe 1233, and the current gear position is identified by the base point probe 1232 and the gear position identification probe 1234. The base point probe 1232 is electrically connected with the circuit board 3100, and can be used for communicating and transmitting electrical signals, and transmitting the currently identified information to the circuit board 3100. The circuit board 3100 performs calculation processing, controls the image mapping apparatus 2000 to map the contents of the currently corresponding mapping sheet 2120, and controls the sound apparatus 4000 to play out the preset audio information of the currently corresponding mapping sheet 2120.

Referring to FIG. 2 to FIG. 8, the inner bracket 1100 is provided with a battery assembly 1110, which can provide working energy for the whole multifunctional image mapping device. The main body shell 1000 includes a battery cover plate 1600 detachably connected with the main body shell 1000, and the battery cover plate 1600 is detachably connected with the main body shell 1000 through bolts. If the battery assembly 1110 has problems or needs to be replaced, the user can easily replace the battery assembly by disassembling the battery cover plate 1600, and the battery assembly is located on the inner bracket 1100, which can protect the battery assembly from the external environment, thereby improving the reliability of the device.

Referring to FIG. 2 to FIG. 8, the control apparatus 3000 includes a control button 3200, which is arranged on the main body shell 1000 in a penetrating way and consists of a mapping switch 3210 and a start switch 3220, both of which are electrically connected to the circuit board 3100. The start switch 3220 is used to turn on the device, and the mapping switch 3210 controls the switch of the light source 2200. The mapping switch 3210 and the start switch 3220 have clear functions, and they are used to control the switch of the light source 2200 and turn on the device, respectively, and the user can operate as required.

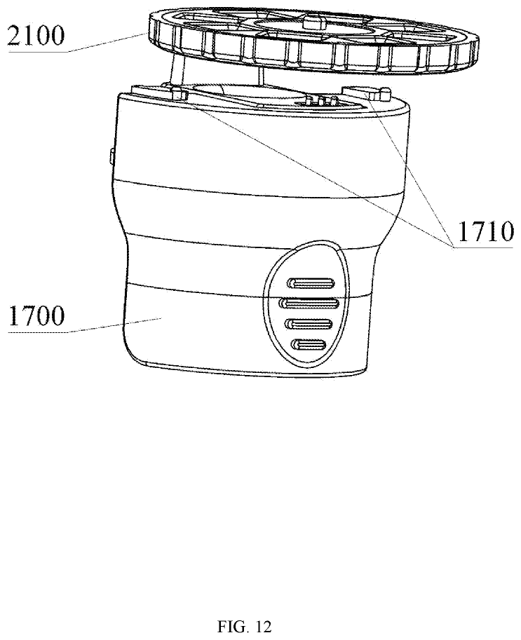

As shown in FIG. 12, the main body shell 1000 further includes a cover plate 1700, and two sides of the top end face of the cover plate 1700 are respectively provided with fixing blocks 1710, which can be used for fixing the mapping disc 2100, so as to ensure the stability of the device during use, protect the probe from being damaged, and improve the durability of the device.

In this embodiment, the inner bracket 1100 is provided with two bolt holes for connecting the circuit board 3100, and the circuit board 3100 is fixed on the inner bracket 1100 through the bolt holes, so as to ensure the stability and reliability of the circuit board 3100 during the use of device; the maximum diameter of the lower end 1500 of the main body shell 1000 is smaller than that of the upper end 1400 of the main body shell, so that the lower end 1500 is more suitable for users to hold, and the use comfort of the device is improved; there are three lithium batteries in the battery assembly 1110, which can provide lasting power for the device and keep the normal operation of the device.

In this embodiment, when the multifunctional image mapping device is used, the battery assembly 1110 prevents the battery from providing power, and the device is powered and turned on by pressing the start switch 3220. The mapping disc 2100 is rotated to select the content of the mapping sheet 2120 to be mapped, and the mapping switch 3210 is pressed to turn on the light source 2200, so that the light emitted by the light source 2200 passes through the mapping sheet 2120 by being condensed by the condenser lens 1210. Then it passes through the second lens 1320 and the first lens 1310 in turn, so that the projection distance is increased and the projected pattern is enlarged. At the same time, the identification apparatus 1230 recognizes the information on the coding disc 2140 on the mapping disc 2100 and communicates with the circuit board 3100 through the resistance value identification area 2132 and the base point area 2131. The circuit board 3100 is provided with a circuit to process the currently recognized content and map it to the corresponding content, and the sound apparatus 400 plays the audio file. When the current mapping content needs to be changed, the current content can be changed only by rotating the mapping disc 2100. The first lens 1310 and the second lens 1320 form a lens group, and the distance between the first lens 1310 and the second lens 1320 is fixed. The user can change the distance between the lens group and the mapping disc 2100 by turning the knob 2310 to change the focal length. The circuit board 3100 belongs to the prior art and can be easily implemented by technicians in the basic field, and therefore the structure and working principle of the circuit board 3100 are not described here.

In this embodiment, the circuit board 3100 can match a large amount of picture content information, and it is easy to expand, and the product information is rich and diverse, and it is easy to operate. The design of the circuit board 3100 makes data processing more efficient and can quickly match the content information. Users do not need complicated operation procedures, and just needs to turn on the device, rotate the mapping disc 2100 and turn on the mapping switch 3210, therefore users can choose a plurality of mapping discs 2100 independently, thus having more and richer mapping contents, and playing corresponding audio according to the current mapping contents, thus enhancing the user's experience.

In other embodiments, the encoding information in the coding disc can be encoded in three-bit binary codes (the three-bit binary code is a coding method that uses three binary bits (0 or 1) to represent information; each binary bit can have two possible states (0 or 1), and thus the three-bit binary code can represent 2\hat{ }3=8 different states, including 000; 001; 010; 011; 100; 101; 110; 111, and two state of “0” and “1” in the codes are realized by using the point where the resistance identification probe 1233 and the gear recognition area 2133 contact with the power supply). The three-digit binary code can represent 1-8 pictures; the mapping disc 2100 can also be provided with four mapping sheets 2120, and the coding information adopts two-bit binary codes, which can represent 1-4 pictures.

In other embodiments, in addition to the above-mentioned identifying method by different gear resistance values and the method of digital coding (binary coding), the coding information can also adopt analog coding or any other desired coding types.

In another embodiment, the battery assembly 1110 can adopt different types of batteries such as lithium battery, nickel-metal hydride battery and alkaline battery, or change to various charging methods such as wired charging, wireless charging or solar energy, or a power adapter, so that the device can be directly powered through a power socket; if the device needs to be used in the vehicle, the car charger may be considered for charging the device.

In other embodiments, the port positions on the main body of the mapping disc 2100 can be randomly combined, for example, the resistance value identification area 2132, the gear recognition area 2133 and the base point area 2131 are sequentially arranged from the inside to the outside, or in other desired orders.

In other embodiments, the control apparatus 3000 includes a replacement button (not shown in the figure), which can rotate the mapping disc 2100 to replace the currently projected content.

In other embodiments, the lower end 1500 of the main body shell 1000 can be provided with anti-slip lines, which can increase the friction between the user's palm and the main body shell 1000, reduce the sliding of the multifunctional image mapping device caused by unexpected factors, and reduce the risk of damage.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

1. A multifunctional image mapping device, comprising a main body shell, an image mapping apparatus, a control apparatus and a sound apparatus;
wherein, an inner bracket, a mapping bracket and a lens bracket are arranged inside said main body shell; and
wherein, said image mapping apparatus comprises a mapping disc, a light source and a lens assembly, wherein said mapping disc is provided with a plurality of mapping ports, mapping sheets are arranged in the plurality of mapping ports, and said mapping disc is also provided with coding information corresponding to each mapping sheet, wherein said mapping disc is rotatably coupled to said mapping bracket, said lens assembly is arranged in said lens bracket, and said light source is arranged in said mapping bracket, wherein said mapping port can be aligned with the lens assembly and the light source through the rotation of said mapping disc;
wherein, said control apparatus and said sound apparatus are arranged on said inner bracket, and said control apparatus comprises a circuit board which is electrically connected with said image mapping apparatus and said sound apparatus; and
wherein when a user rotates said mapping disc, said circuit board recognizes the coding information of said mapping sheet aligned with said lens assembly, and controls said light source and said sound apparatus to work according to a preset program.

2. The multifunctional image mapping device according to claim 1, wherein said mapping disc further comprises a mapping disc main body and a mapping disc upper cover, and said mapping port is arranged on said mapping disc upper cover; and said mapping disc main body is divided into a port disc, a coding disc and a mapping sheet placement area, wherein said port disc comprises a base point area, a resistance value identification area and a gear position identification area; said port disc is electrically connected with said circuit board, said coding disc is arranged at a rear side of said port disc, and said coding disc is provided with pre-stored coding information, and said mapping sheets are placed in the mapping sheet placement area, and each mapping sheet corresponds to the coding information on said coding disc.

3. The multifunctional image mapping device according to claim 2, wherein said mapping disc is further provided with a rotating shaft, a center of said mapping disc passes through said rotating shaft, and said mapping ports are distributed on said mapping disc at a same angle with said rotating shaft as a center.

4. The multifunctional image mapping device according to claim 3, wherein said main body shell is provided with a plurality of speaker holes, and a sound propagation path is provided above said speaker holes and said sound apparatus.

5. The multifunctional image mapping device according to claim 4, wherein said mapping bracket is further provided with a condenser lens, and said condenser lens is arranged above said light source.

6. The multifunctional image mapping device according to claim 5, wherein said mapping bracket comprises an identification probe, and said identification probe is composed of a plurality of spring probes with different functions, and said spring probes comprise a base point probe, a resistance identification probe and a gear position identification probe.

7. The multifunctional image mapping device according to claim 6, wherein said base point probe is in contact with said base point area, said resistance identification probe is in contact with said resistance value identification area, and said gear position identification probe is in contact with said gear position identification area.

8. The multifunctional image mapping device according to claim 7, wherein said base point probe is electrically connected with said circuit board, said base point probe recognizes said coding information and transmits said coding information to said circuit board, and said circuit board controls said image mapping apparatus and said sound apparatus to work.

9. The multifunctional image mapping device according to claim 8, wherein said lens bracket comprises a first lens and a second lens, and said second lens is arranged below said first lens.

10. The multifunctional image mapping device according to claim 9, wherein a battery assembly is arranged inside said inner bracket, and said battery assembly provides working energy for said multifunctional image mapping device to operate.

11. The multifunctional image mapping device according to claim 10, wherein said main body shell has an upper end and a lower end, said inner bracket is arranged at said lower end, and said mapping bracket and said lens bracket are arranged at said upper end.

12. The multifunctional image mapping device according to claim 11, wherein said upper end is fixedly connected to said lower end through arc transition, and both said upper end and said lower end have maximum diameters, and the maximum diameter of said upper end is greater than that of said lower end.

13. The multifunctional image mapping device according to claim 12, wherein said main body shell further comprises a cover plate, and two sides of a top end face of said cover plate are respectively provided with fixing blocks for fixing said mapping disc.

14. The multifunctional image mapping device according to claim 13, wherein said main body shell comprises a battery cover plate detachably connected with said main body shell, and said battery cover plate is detachably connected with said main body shell by bolts.

15. The multifunctional image mapping device according to claim 14, wherein said control apparatus comprises a control button, which is arranged on said main body shell in a penetrating way, and comprises a mapping switch and a start switch, both of which are electrically connected with said circuit board.

16. A multifunctional image mapping device, comprising a main body shell, an image mapping apparatus, a control apparatus and a sound apparatus;
wherein, an inner bracket, a mapping bracket, a lens bracket and a knob are arranged inside said main body shell; and
wherein, said image mapping apparatus comprises a mapping disc, a light source and a lens assembly, wherein said mapping disc is provided with a plurality of mapping ports, mapping sheets are arranged in said mapping ports, and said mapping disc is also provided with coding information corresponding to each mapping sheet, wherein said mapping disc is rotatably coupled to said mapping bracket, said lens assembly is arranged in said lens bracket, and said light source is arranged in said mapping bracket, wherein said mapping port can be aligned with said lens assembly and said light source through the rotation of said mapping disc;
wherein said knob is operatively connected to said lens assembly to adjust a focal length of said lens assembly; and
wherein, said control apparatus and said sound apparatus are arranged on said inner bracket, and said control apparatus comprises a circuit board, wherein said circuit board is provided with an identification probe which is in contact with said mapping disc, and when said mapping disc rotates, said identification probe can read the coding information of said mapping sheet aligned with said lens assembly; and
wherein when said control apparatus receives an input instruction from a user, said control apparatus controls said light source and said sound apparatus to work according to a preset program.

17. The multifunctional image mapping device according to claim 16, wherein said knob is arranged at an outer side of said lens bracket, and said lens bracket is provided with an adjusting thread, and said knob is rotationally matched with a rotating adjusting thread, and a distance H between said lens bracket and said mapping disc can be adjusted by rotating said knob, thereby adjusting the focal length.

18. A method for mapping an image, said method comprising providing a multifunctional image mapping device comprising a main body shell, an image mapping apparatus, a control apparatus and a sound apparatus;
wherein, an inner bracket, a mapping bracket, a lens bracket and a knob are arranged inside said main body shell; and
wherein, said image mapping apparatus comprises a mapping disc, a light source and a lens assembly, wherein said mapping disc is provided with a plurality of mapping ports, mapping sheets are arranged in said mapping ports, and said mapping disc is also provided with coding information corresponding to each mapping sheet, wherein said mapping disc is rotatably coupled to said mapping bracket, said lens assembly is arranged in said lens bracket, and said light source is arranged in said mapping bracket, wherein said mapping port can be aligned with said lens assembly and said light source through the rotation of said mapping disc;
wherein said knob is operatively connected to said lens assembly to adjust a focal length of said lens assembly; and
wherein, said control apparatus and said sound apparatus are arranged on said inner bracket, and said control apparatus comprises a circuit board, wherein said circuit board is provided with an identification probe which is in contact with said mapping disc, and when said mapping disc rotates, said identification probe can read the coding information of said mapping sheet aligned with said lens assembly; and
wherein when said control apparatus receives an input instruction from a user, said control apparatus controls said light source and said sound apparatus to work according to a preset program; and
the method comprises the following steps:
turning on said multifunctional image mapping device through said control apparatus;
rotating said mapping disc and selecting a mapping sheet to be mapped;
rotating said knob to select an appropriate focal length; and
mapping by said control apparatus.

19. The method according to claim 18, wherein before turning on said multifunctional image mapping device through said control apparatus, a user can choose to place different mapping discs.

20. The method according to claim 19, wherein when the user uses said multifunctional image mapping device, said mapping disc can be manually rotated to select different mapping sheets, thereby mapping contents of different mapping sheets.
